(19) United States
(12) Patent Application Publication
(10) Pub. No.: US 2003/0023799 A1
(43) Pub. Date: Jan. 30, 2003

(54) Interrupt processing apparatus

(75) Inventors: Ho-Sun Yoo, Seongnam-City (KR); In-Su Yang, Seoul (KR)

Correspondence Address: STAAS & HALSEY LLP, 700 11TH STREET, NW, SUITE 500, WASHINGTON, DC, 20001, US

(73) Assignee: Samsung Electronics Co., Ltd, Suwon-city (KR)

(21) Appl. No.: 09/960,933

(22) Filed: Sep. 25, 2001

(30) Foreign Application Priority Data
Jul. 6, 2001 (KR) 2001-40422

(51) Int. Cl. G06F 13/24

(52) U.S. Cl. 710/260

(57) ABSTRACT

An interrupt processing apparatus is disclosed. The apparatus processes interrupts from a plurality of interrupt sources by a central processing unit having one or more input ports. The apparatus has an interrupt controller for outputting an interrupt request signal for requesting an interrupt process from a corresponding interrupt source to a designated input port if the central processing unit assigns a priority to the corresponding interrupt source which generates the interrupt such that the apparatus processes interrupts from the interrupt sources more than the number of the input ports. The interrupt controller has a detection unit and a signal generating unit for outputting the interrupt request signal to a designated input port in conjunction with an operation of the detection unit.

### BACKGROUND OF THE INVENTION

1. Field of the Invention

The present invention relates in general to an interrupt processing apparatus, and more particularly to an apparatus for processing interrupts from a plurality of interrupt sources more than the number of input ports of a central processing unit.

2. Description of the Prior Art

Generally, a commercial central processing unit(CPU) is widely used to control motors for industrial robots, as well as personal computers. Such a central processing unit executes a corresponding interrupt service routine(or interrupt routine) in response to an interrupt request received through an input port of the CPU during an execution of a given operating program, thus responding to various unexpected situations.

The interrupts are classified into external interrupts and internal interrupts. The external interrupts can be generated by requests of input/output peripheral units, or by intended discontinuity in response to the user's operation. The internal interrupts can be generated by a programming problem such as an execution of wrong instruction while executing a program.

The central processing unit has input ports for receiving interrupt request signals from interrupt sources generating the external interrupts or the internal interrupts. Typically, the number of the input ports is 2 to 8. However, because it is impossible to increase the number of input ports previously formed to the CPU, the CPU is restricted in its ability to process the interrupts from more interrupt sources, thus complicating the processing operation of programs. Alternatively, development of a new central processing unit having a large number of input ports would incur high manufacturing costs.

So, in order to solve such problem, the conventional central processing unit employs a wired-AND method for connecting a plurality of interrupt sources to one input port.

FIG. 1 is a view showing a conventional interrupt processing apparatus. Referring to FIG. 1, a central processing unit CPU has input ports E1 to E4 for being connected to interrupt sources, respectively. For example, the input port E1 is commonly connected to a plurality of interrupt sources. The CPU processes an interrupt corresponding to an interrupt request generated from any one of the interrupt sources commonly connected to the input port E1.

However, while the conventional interrupt processing apparatus can process interrupts from a plurality of interrupt sources, it cannot assign a priority to each interrupt to decide which interrupt has to be processed first among two or more interrupts in the case of receiving the interrupts simultaneously from two or more interrupt sources. For this reason, the conventional interrupt processing apparatus is problematic in that it cannot be commonly applied to various systems in which the number of the interrupt sources varies according to a system situation, thus limiting the design of systems having a variety of functions.

Further, in the conventional interrupt processing apparatus, when the CPU receives a request to process an interrupt routine B from a second interrupt source during a processing of an interrupt routine A by a request from a first interrupt source, the CPU may discontinue the interrupt routine A in execution, to execute the interrupt routine B. Alternatively, the CPU continues to execute the interrupt routine A while delaying the processing of the interrupt routine B, and later executes the interrupt routine B after the interrupt routine A is completed. As described above, in the conventional interrupt processing apparatus, the central processing unit is problematic in that it cannot process interrupts from two or more interrupt sources simultaneously.

### SUMMARY OF THE INVENTION

Therefore, the present invention has been made in view of the above problems, and it is an object of the present invention to provide an interrupt processing apparatus for simultaneously processing interrupts from a plurality of interrupt sources.

It is another object of the present invention to provide an interrupt processing apparatus for assigning a priority to interrupt sources more than the number of input ports so as to process the interrupts, and for changing the assigned priority, thus enabling the apparatus to be commonly adapted in a variety of systems.

In accordance with one aspect of the present invention, the above and other objects can be accomplished by the provision of an interrupt processing apparatus for processing interrupts from a plurality of interrupt sources by a central processing unit having one or more input ports, comprising an interrupt controller for outputting an interrupt request signal for requesting an interrupt process from a corresponding interrupt source to a designated input port if the central processing unit assigns a priority to the corresponding interrupt source which generates the interrupt such that the apparatus processes interrupts from interrupt sources more than the number of the input ports.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of a conventional interrupt processing apparatus;

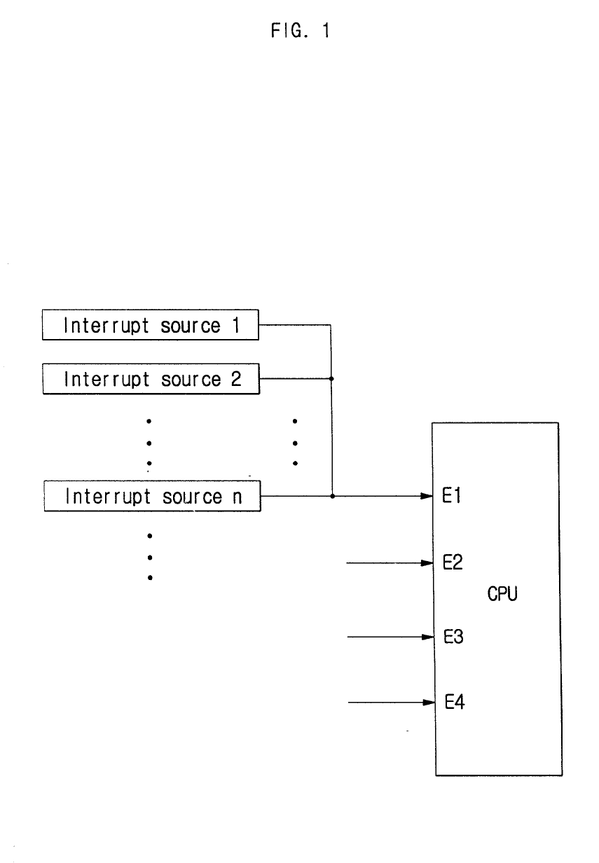

FIG. 2 is a block diagram showing the construction of an interrupt processing apparatus according to the preferred embodiment of the present invention;

FIG. 3 is a view showing an interrupt mask register and an interrupt flag register of this invention;

FIG. 4 is a flowchart of the operation processed by an interrupt controller of this invention; and

FIG. 5 is a flowchart of the operation processed by a central processing unit of this invention.

### DETAILED DESCRIPTION OF THE PREFERRED EMBODIMENTS

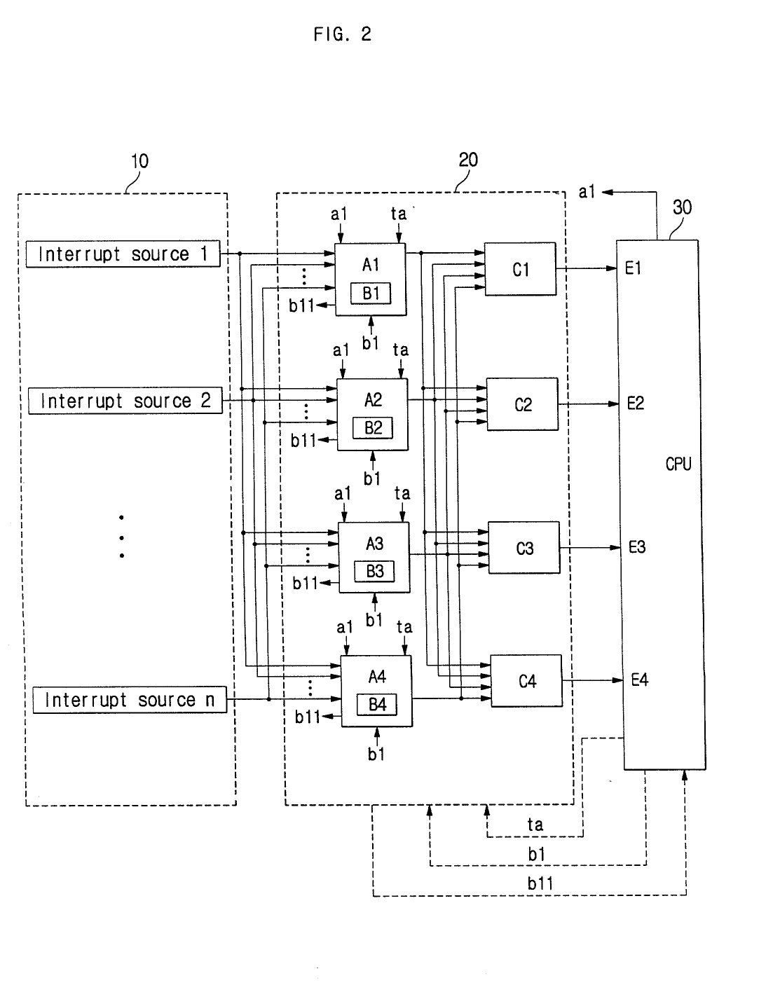

FIG. 2 is a block diagram showing the construction of an interrupt processing apparatus according to the preferred embodiment of the present invention.

Referring to FIG. 2, the interrupt processing apparatus of this invention comprises an interrupt generating unit 10, a central processing unit(CPU) 30, and an interrupt controller 20. The interrupt generating unit 10 has a plurality of interrupt sources 1 to n. The central processing unit 30 has a plurality of input ports E1 to E4 for receiving interrupt request signals. The interrupt controller 20 is connected between the interrupt generating unit 10 and the central processing unit 30.

The interrupt sources 1 to n of the interrupt generating unit 10 each output an interrupt generating signal to the interrupt controller 20 when it is desired to perform an interrupt.

The interrupt controller 20 includes a plurality of detection units A1 to A4, and a plurality of signal generating units C1 to C4. The detection units A1 to A4 each receive an interrupt generating signal from the interrupt sources 1 to n, and output a detection signal if the priority is assigned to each interrupt source. The signal generating units C1 to C4 each output an interrupt request signal to a corresponding input port of the CPU 30 according to each detection signal from the detection units A1 to A4.

Each output port of the detection units A1 to A4 is commonly connected to all input terminals of the signal generating units C1 to C4. Further, the detection units A1 to A4 each output a detection signal to a corresponding signal generating unit determined according to a selection control signal a1 from the CPU 30. The signal generating units C1 to C4 are connected to the input ports E1 to E4 of the CPU 30, respectively, such that the units C1 to C4 each output an interrupt request signal to a corresponding input port of the CPU 30.

The detection units A1 to A4 include a plurality of storage units B1 to B4.

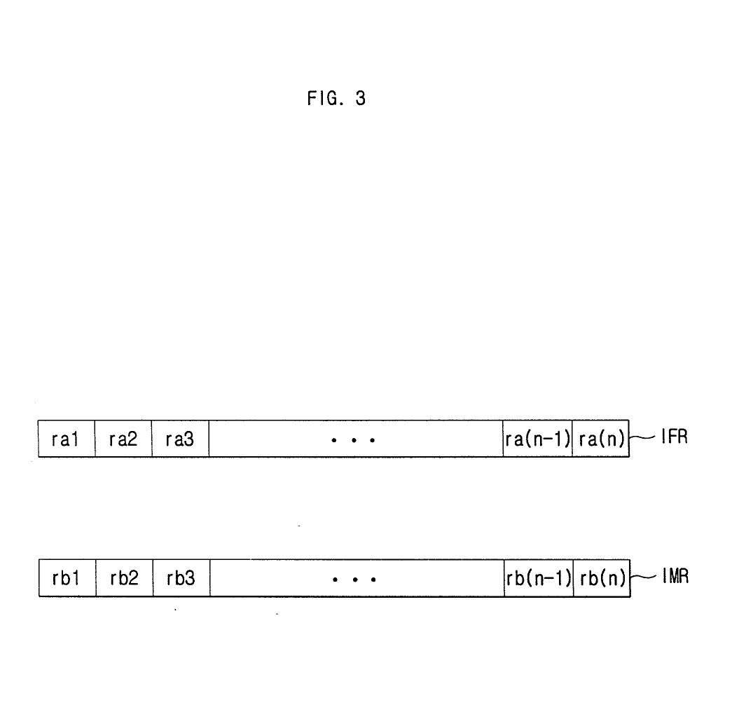

FIG. 3 is a view showing an interrupt flag register and an interrupt mask register of this invention. Referring to FIG. 3, the storage units B1 to B4 each include an interrupt flag register(IFR) and an interrupt mask register(IMR) corresponding to the interrupt sources. The IFR sets a predetermined bit according to the interrupts generated from the interrupt sources 1 to n. The IMR sets a predetermined bit according to whether or not the priority is assigned to each interrupt source. For example, a bit ra1 of the IFR is set to logic “1” when the interrupt is generated from the interrupt source 1. On the other hand, the bit rb1 of the IMR is set to logic “1” when the priority is assigned to the interrupt source 1.

For this operation, the CPU 30 previously outputs an assigning control signal b1 for assigning priorities to the plurality of the interrupt sources 1 to n to the detection units A1 to A4. Thereby, each IMR of the storage units B1 to B4 sets the predetermined bit to logic “1” if the priority is assigned to each interrupt source in response to the assigning control signal b1, while clearing the predetermined bit to logic “0” if the priority is not assigned. The CPU 30 can set or clear the predetermined bit of each IMR of the storage units B1 to B4, for example to logic “1” or logic “0”, with respect to an interrupt from the same interrupt source. For example, the CPU 30 assigns a priority to an IMR of the storage unit B1 with respect to the interrupt source 1, thus setting the predetermined bit to logic “1”, while not assigning any priority to the IMRs of the remaining storage units B2, B3 and B4, thus clearing the predetermined bits to logic “0”. As another example, the CPU 30 simultaneously assigns priorities to IMRs of the storage units B1 and B2 with respect to interrupt source 2, thus setting the predetermined bits of the IMRs of the units B1 and B2 to logic “1”, while not assigning any priority to the IMRs of the remaining storage units B3 and B4, thus clearing the predetermined bits thereof to logic “0”.

Each of the detection units A1 to A4 ANDs each bit of the IFR and the IMR, and if the AND results are all “0”, there are no interrupts, and then the detection units A1 to A4 do not output any detection signal.

On the other hand, if all the AND results are not “0”, in other words, any one of the AND results is “1”, then there is an interrupt, and a corresponding detection unit outputs a detection signal to an associated signal generating unit. For example, providing that the priority is assigned to the interrupt source 2, and the bit rb2 of the IMR of the storage unit B1 is set to “1”, then a detection signal of the detection unit A1 is outputted in response to the selection control signal a1, if the predetermined bit ra2 of the IFR is set to “1” due to the interrupt from the interrupt source 2, the AND result of two bits ra of IFR and rb of IMR corresponding to the interrupt source 2 is logic “1”. As a result, the storage unit A1 outputs a detection signal to the signal generating unit C1 determined according to the selection control signal a1. At this time, the signal generating unit C1 applies the interrupt request signal to the input port E1 corresponding to the signal generating unit C1. If the interrupt request signal is received through the input port E1, the CPU 30 discontinues an operation program in current execution, and executes an interrupt routine from the interrupt source 2. In this case, when completing its execution of the interrupt routine, the CPU 30 outputs a clear control signal ta for clearing the predetermined bit ra2 of the IFR. Then, the interrupt flag register IFR clears the bit ra2 to “0” in response to the clear control signal ta.

On the other hand, the interrupt processing apparatus of this invention can simultaneously process interrupts from two or more interrupt sources. As an example, an operation of processing the interrupts from the interrupt sources 1 and 2 is described. For this operation, a priority is previously assigned to the storage unit B1 corresponding to the interrupt source 1, and a priority is assigned to the storage unit B2 corresponding to the interrupt source 2. Thereby, the bit rb1 of the IMR of the storage unit B1 is set to “1”, and the bit rb2 of the IMR of the storage unit B2 is set to “1”. Due to the interrupt generated from the interrupt source 1, the bit ra1 of the IFR of the storage unit B1 is set to “1”, and AND result of the ra1 and rb1 is “1”. The signal generating unit C1 applies the interrupt request signal to the input port E1 of the CPU 30 in response to the detection signal from the detection unit A1. Accordingly, the CPU 30 executes the interrupt routine A corresponding to the interrupt source 1 in response to the interrupt request signal. As described above, if the interrupt is generated from the interrupt source 2 during an execution of the interrupt routine A, the bit ra2 of the IFR of the storage unit B2 is set to “1”, and the AND result of the bits ra2 and the rb2 is “1”, such that the interrupt request signal is applied to the CPU 30 not through the input port E1, but through one of other input ports. The CPU 30 can execute the interrupt routine B corresponding to the interrupt source 2 at the same time it executes the interrupt routine A.

Further, the CPU 30 can process an internal interrupt that is internally generated. First, in state of compulsorily setting the predetermined bit of the IMR to “1”, if the predetermined bit of the IFR is compulsorily set to “1” when the internal interrupt is generated, the interrupt request signal is applied to a predetermined input port of the CPU 30, thus allowing the CPU 30 to execute an internal interrupt routine corresponding to the internal interrupt.

Hereinafter, the interrupt processing method of this invention is described in detail, referring to drawings.

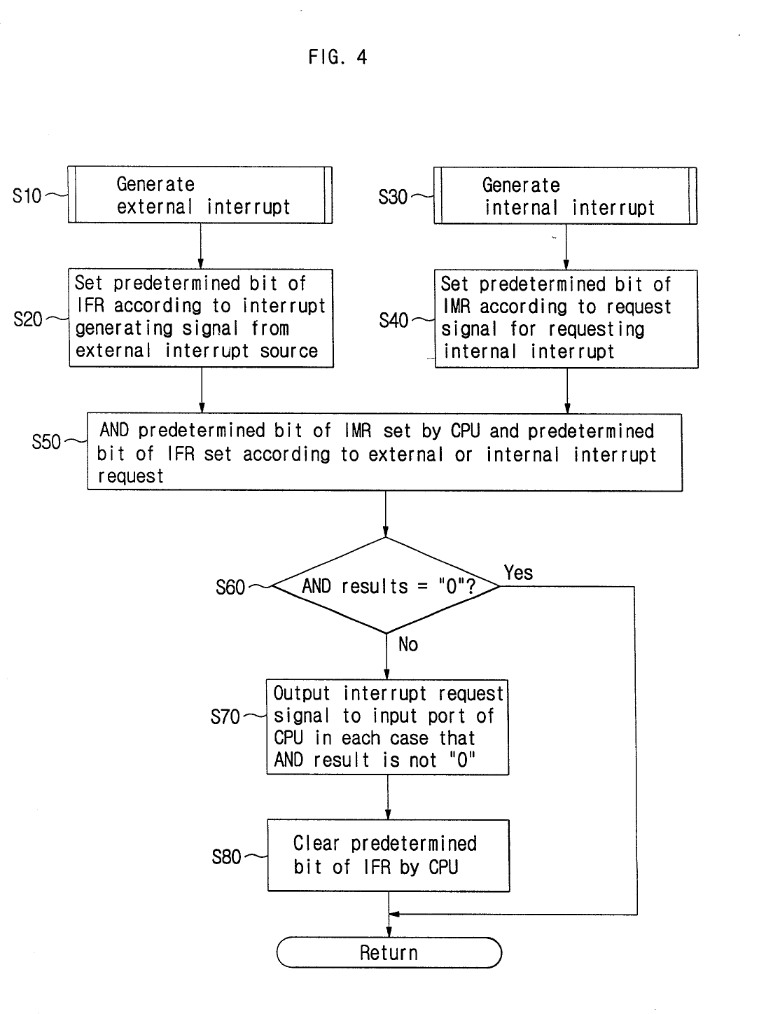

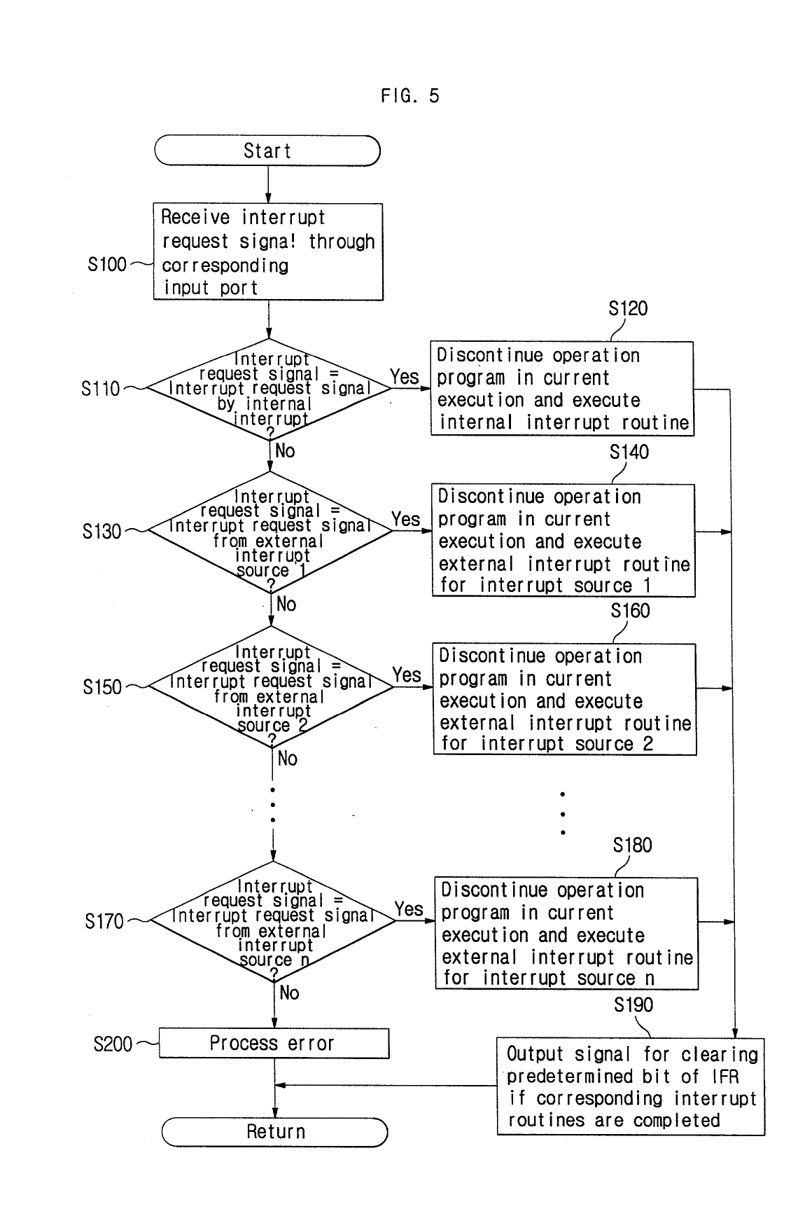

FIG. 4 is a flowchart of the operation processed by the interrupt controller 20 of this invention, and FIG. 5 is a flowchart of the operation processed by the CPU 30.

Referring to FIG. 4, each interrupt source of the interrupt generating unit 10 outputs an interrupt generating signal to each of the detection units A1 to A4 if it is required to process an interrupt at step S10. Each of the detection units A1 to A4 sets the predetermined bit of the IFR of the storage units B1 to B4 to “1” according to a generated interrupt at step S20.

When the internal interrupt is generated, the CPU 30 outputs a request signal for requesting the internal interrupt to the detection units A1 to A4 at step S30, and the predetermined bit of the IFRs of the storage units B1 to B4 is set to “1” at step S40.

After the steps S20 and S40, the predetermined bits of the IFR and IMR are ANDed at step S50, wherein the IMR is preset by the CPU 30, corresponding to the external interrupts from the plurality of interrupt sources, or compulsory internal interrupts.

The detection units A1 to A4 determine whether or not all the AND results are “0” at step S60. If all the AND results are “0”, the detection units A1 to A4 recognize that either the external interrupts or the internal interrupts are not generated, and returns to the initial processing steps, without outputting any detection signal.

On the other hand, if all the AND results are not “0” at step S60, the detection units A1 to A4 output the detection signal to corresponding signal generating units C1 to C4, and the signal generating units C1 to C4 apply the interrupt request signal in response to the detection signal to the corresponding input ports E1 to E4 at step S70.

Next, if the clear control signal ta is received from the CPU 30, the predetermined bit of the IFR, which has been set to “1”, is cleared to “0” at step S80, and then the processing step is returned to the initial step to repeat the process.

Referring to FIG. 5, the operation of processing the external interrupt and the internal interrupt while performing the operation program by the CPU 30 is described. First, the CPU 30 receives the interrupt request signal from the interrupt controller 20 through the input ports E1 to E4 at step S100.

Then, the CPU 30 determines whether or not the interrupt request signal is an internal interrupt request signal due to an internal interrupt at step S110. If the interrupt request signal is an internal interrupt request signal, the CPU 30 discontinues the operation program in current execution, and executes the internal interrupt routine at step S120.

Based on the determination result at step S120, if the interrupt request signal is not an internal interrupt request signal, the CPU 30 determines whether or not the interrupt request signal is an external interrupt request signal from the external interrupt sources 1 to n at steps S130, S150, and S170. If the interrupt request signal is an external interrupt request signal from a corresponding interrupt source, the CPU 30 discontinues the operation program in current execution, and executes the external interrupt routine at steps S140, S160, and S180. When completing its execution, the CPU 30 outputs a clear control signal for clearing the predetermined bit of the IFR to each detection unit A1 to A4 at step S190, prior to returning to the initial step in order to repeat the process.

As a result of the determinations at steps S110, S130, S150 and S170, if the interrupt request signal is not an external interrupt request signal from the external request sources 1 to n, the CPU 30 processes an error for the signal at step S200, and then the process is returned to the initial step.

Further, during an execution of the interrupt routines at step S120, S140, S160, and S180, if an external or internal interrupt is generated, the CPU 30 receives the interrupt request signal through other input ports, such that it can execute the recently generated interrupt routine in parallel with the interrupt routine in execution.

Further, it is well known in the field that during an execution of the interrupt routine, the CPU 30 outputs the assigning control signal b1, thus enabling the CPU 30 to assign a priority to the interrupt sources, or to release the assigned priority, and so a detail description is deemed unnecessary.

As apparent from the above description, the present invention provides an interrupt processing apparatus for assigning a priority to a plurality of interrupt sources more than the number of input ports of a CPU so as to process the interrupts, thus simultaneously processing a plurality of interrupts without difficulty. Further, the present invention can be commonly adapted in a variety of systems having different numbers of interrupt sources and different functions.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An interrupt processing apparatus for processing interrupts from a plurality of interrupt sources by a central processing unit having one or more input ports, comprising:
an interrupt controller for outputting an interrupt request signal for requesting an interrupt process from a corresponding interrupt source to a designated input port if the central processing unit assigns a priority to the corresponding interrupt source which generates the interrupt such that the apparatus processes interrupts from interrupt sources more than the number of the input ports.

2. The apparatus as set forth in claim 1, wherein the interrupt controller includes a detection unit for detecting the interrupts generated from the interrupt sources and assigning a priority to the interrupt sources, and a signal generating unit for outputting the interrupt request signal to a designated input port in conjunction with an operation of the detection unit.

3. The apparatus as set forth in claim 2, wherein the detection unit and the signal generating unit are plural in their numbers, respectively, in order to correspond to the number of the input ports.

4. The apparatus as set forth in claim 2, wherein the detection unit includes a storage unit having a first register for setting a predetermined bit according to whether or not an interrupt is generated from the interrupt sources, and a second register for setting a predetermined bit according to whether or not a priority is assigned to the interrupt sources.

5. The apparatus as set forth in claim 2, wherein each output port of the detection units is commonly connected to all the signal generating units, such that each detection unit outputs a detection signal to a corresponding signal generating unit, and output ports of the signal generating units are connected to the input ports, respectively, such that the signal generating units each output the interrupt request signal to the designated input port.

6. The apparatus as set forth in claim 4, wherein each detection unit sets the predetermined bit of the first register corresponding to the interrupt source originating the interrupt, and sets the predetermined bit of the second register corresponding to the interrupt source to be assigned the priority according to an assigning control signal from the central processing unit, and thereby outputs a detection signal if the predetermined bits of the first and second registers are set.
